(19) United States
(12) Patent Application Publication
(10) Pub. No.: US 2003/0135456 A1
(43) Pub. Date: Jul. 17, 2003

(54) Method and system for receiving an alert code in a commercial transaction

(75) Inventors: Thomas E. Murphy JR., Vestal, NY (US); Francine M. Orzel, Endicott, NY (US); Alice D. Rostedt, Endwell, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/047,307

(22) Filed: Jan. 15, 2002

(51) Int. Cl. G06F 17/60

(52) U.S. Cl. 705/39

(57) ABSTRACT

A method and system for receiving an alert code in a commercial transaction is provided. Specifically, a sender wishing to send a message will contact a message center. The next time a transactional device, such as a credit/debit card, belonging to the intended recipient is used during a commercial transaction, an alert code will be attached to transaction data. The alert code will alert the recipient of the presence of the message, who could then contact the sender or the message center to retrieve the message.

### BACKGROUND OF THE INVENTION

1. Field of the Invention

The present invention relates to a method and system for receiving an alert code in a commercial transaction. In particular, the present invention allows an individual engaging in a commercial transaction to receive an alert code pertaining to a message.

2. Background Art

As travel becomes more proficient, travelers are increasingly seeking better ways to maintain communication with family, friends and co-workers. Specifically, a person on a work-related trip or a vacation may be away for an extended period of time. During this time, it could be necessary for others to contact the traveler. Currently, many people use cellular phones, pagers, and other electronic devices to maintain communication. Problems arise, however, when these electronic devices fail to function properly. For example, a cellular phone or pager might be out of range, or have batteries that must be frequently changed or recharged. Moreover, many people choose not utilize such electronic devices due to their often disruptive nature.

These problems are compounded when people attempting to contact a traveler is not aware of the traveler's itinerary. In particular, the traveler could be making several stops on his/her trip and staying in several different hotels. Unless the person attempting to contact the traveler knows exactly where the traveler will be and when, there might be no efficient way to make contact.

One manner in which a traveler's whereabouts could be determined is by tracking the use of certain transactional devices such as credit/debit cards. Today's traveler often relies heavily on such devices to minimize the amount of cash that must be carried. Accordingly, it is common for the majority of travel expenses to be put on a credit/debit card. Unfortunately, no existing solution provides a way for a message to be conveyed to a traveler upon his/her use of such transactional devices.

In view of the foregoing, there exists a need of for a method and system for receiving an alert code during a commercial transaction. In addition a need exists for a user of a transactional device to be alerted of the presence of a message.

### SUMMARY OF THE INVENTION

The present invention overcomes the drawbacks of existing systems by providing a method and system for receiving an alert code during a commercial transaction. Specifically, under the present invention, a person with a message for a traveler can contact a message center. The next time a transactional device belonging to the traveler is used, an alert code will be attached to transaction data. For example, if the traveler uses a MasterCard to pay for a dinner, an alert code could be prominently attached to the authorization code that is printed on the credit card receipt. After seeing the alert code, the traveler can contact the message center, or the sender (if known), and retrieve the message. Thus, the traveler can receive a message without reliance on personal communication devices.

According to a first aspect of the present invention, a method for receiving an alert code in a commercial transaction is provided. The method comprises the steps of: (1) using a transactional device in a commercial transaction; and (2) receiving an alert code attached to transaction data for the commercial transaction.

According to a second aspect of the present invention, a method for receiving an alert code in a commercial transaction is provided. The method comprises the steps of: (1) contacting a message center with a message; (2) using a transactional device in a commercial transaction; (3) identifying an intended recipient of the message; (4) attaching an alert code to transaction data for the transaction, wherein the alert code is unrelated to the transaction; (5) receiving the alert code attached to the transaction data; and (6) retrieving the message in response to the received alert code.

According to a third aspect of the present invention, a system for receiving an alert code in a commercial transaction is provided. The system comprises: (1) a message reception system for receiving a message; (2) a recipient identification system for identifying an intended recipient of the message based upon use of a transactional device during a commercial transaction; (3) an attachment system for attaching an alert code to transaction data for the transaction; and (4) a message transmission system for transmitting the received message.

According to a fourth aspect of the present invention, a program product stored on a recordable medium for receiving an alert code in a commercial transaction. When executed, the program product comprises: (1) program code configured to receive a message; (2) program code configured to identify an intended recipient of the message based upon use of a transactional device during a commercial transaction; (3) program code configured to attach an alert code to transaction data for the commercial transaction; and (4) program code configured to transmit the received message.

Therefore, the present invention provides a method and system for receiving an alert code during a commercial transaction.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a box diagram of a computer system having an alert system in accordance with the present invention.

FIG. 2 depicts an alert code attached to transaction data according to a first embodiment of the present invention.

FIG. 3 depicts an alert code attached to transaction data according to a second embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method and system for receiving an alert code during a commercial transaction. For example, a person sending a message will contact a message center. The next time a transactional device such as a credit/debit card, bar-coded card, Mobil SpeedPass®, etc. belonging to the intended recipient is used, an alert code will be attached to transaction data (e.g., an authorization code) that is communicated to the device user during the underlying transaction. After seeing the alert code, the intended recipient (or his/her agent using the transactional device) can then contact the message center or the sender to retrieve the message.

It should be understood that although the present invention will be described in the context an intended message recipient using his/her own transactional device and receiving the alert code firsthand, this need not be the case. For example, an intended recipient's agent (e.g., family member, assistant, etc.) could be the individual actually using the transactional device. In this case, the agent could either inform the intended recipient of the alert code who will then retrieve the message, or the agent could retrieve the message his/herself (assuming the agent has the authority to do so).

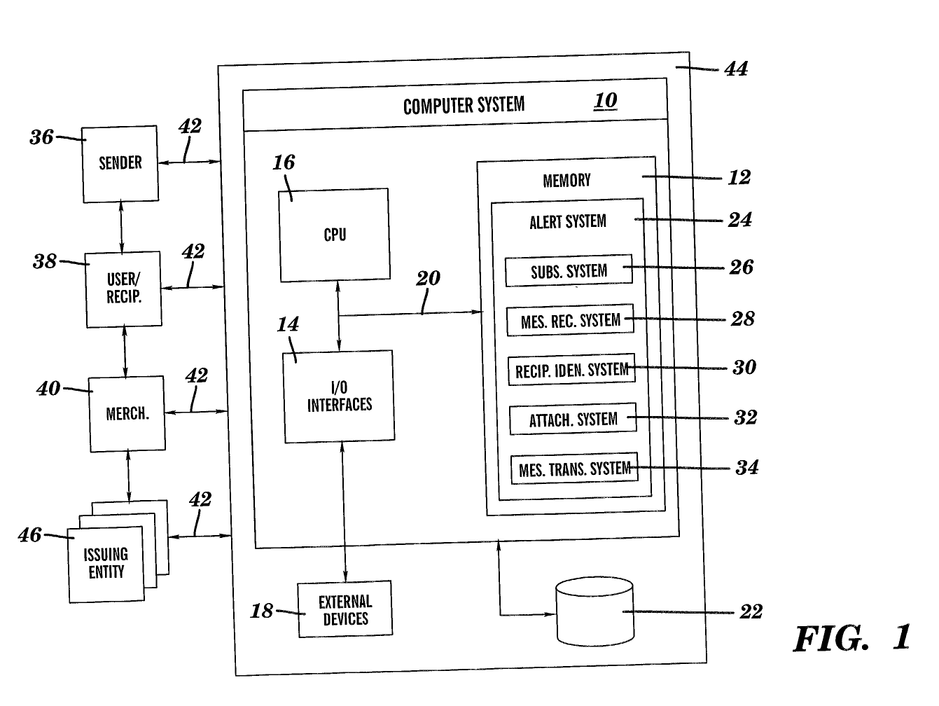

Referring now to FIG. 1, a computer system 10 implementation of the present invention is shown. Computer system 10 generally comprises memory 12, input/output (I/O) interfaces 14, a central processing unit (CPU) 16, external devices/resources 18, bus 20, and database 22. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including a CRT, LED screen, hand-held device, keyboard, mouse, voice recognition system, speech output system, printer, facsimile, pager, personal digital assistant, cellular phone, web phone, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., may be incorporated into computer system 10.

Database 22 could provide storage for information necessary to carry out the present invention. Such information could include, inter alia: (1) messages left by sender 36; and (2) user 38 account information. Database 22 may include one or more storage devices, such as a magnetic disk drive or an optical disk drive. In another preferred embodiment database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

Stored in memory 12 is alert system 24. Alert system 24 allows an alert code to be sent to transactional device user 38 during a commercial transaction with merchant 40. As shown, alert system includes subscription system 26, message reception system 28, recipient identification system 30, attachment system 32, and message transmission system 34. Under the present invention, a potential message recipient who wishes to receive message alerts during a commercial transaction will subscribe to the service via subscription system 26. Subscription can include submitting personal information, designating account options, and assignment of a unique identifier such as a personal identification number (PIN). In addition, the potential message recipient should also identify his/her transactional device(s). As user herein, transactional device is intended to mean any magnetic device, machine-readable code containing device, or other device that can be used by a consumer in a commercial transaction. Examples include credit/debit card, smart card, bar-coded membership organizational cards, Mobil SpeedPass®, etc. Each device could be identified by, for example, credit card number, serial number, etc. In addition, consumer transaction is intended to include not only merchant purchases (e.g., restaurants, hotels, stores, etc.), but also automated transactions (ATMs, gasoline pumps, etc.). Once the potential recipient has subscribed to the service, he/she can receive messages from a sender 36.

As shown, sender 36 wishing to send a message can do so by contacting message center 44. Message center 44 could be an internal department of a specific entity that issued a transactional device (e.g., a particular bank or business). Alternatively, as will be further described below, message center 44 could be a separate entity that provides message management services for several different device issuing entities 46. In either event, sender 36 could contact message center 44 and, through message reception system 28, indicate that he/she wishes to send a message. Message reception system 28 can be personnel, computing hardware, computing software, or any combination thereof. Specifically, message reception system 28 can be automated and prompt sender 36 to identify an intended recipient, such as user 38, using the touch tones on a telephone. Alternatively, message reception system 28 can be a live person that verbally communicates with sender 36. Sender 36 can identify the intended recipient by name, PIN, or other personal information stored in database 22.

Once sender 36 identifies an intended recipient, sender 36 can leave a message with message reception system 28. If message reception system 28 is automated, the message can be recorded. Alternatively, sender 36 may choose not to leave a message and simply identify his/herself. In either event, message reception system 28 will “flag” the intended recipient's account in database 22. Thus, the next time a transactional device belonging to the intended recipient is used during a transaction with merchant 40, recipient identification system 30 will identify the intended recipient. This can be accomplished by comparing the transactional device used in the transaction to flagged accounts in database 22. Specifically, each time a transactional device is used during a commercial transaction, a “transaction request” seeking authorization for the transaction is sent from merchant 40. For authorization to be processed, the transactional device used in the transaction must be identified. Under the present invention, the transactional device identification enumerated in the transaction request is communicated to the message center 44. Recipient identification system 30 can compare the received identification to flagged device identifications stored in database 22. Should a match be established, the intended recipient is identified.

It should be appreciated that, under the present invention, a “transaction request” from merchant 40 could be communicated directly to an entity 46 issuing the particular transactional device (e.g., a bank) or to message center 44. In the case of the former, issuing entity 46 will approve or disapprove the transaction and then communicate with message center 44 to determine whether there are any messages for user 38. In the case of the latter, merchant 40 will directly communicate with message center 44 to check for messages and obtain transaction authorization (authorization can be obtained by message center 44 via communication with issuing entity 46). It should be further understood that, as indicated above, the present invention is applicable when: (1) user 38 is the intended recipient; and/or (2) user 38 is someone other than the intended recipient (e.g., agent, family member, etc.). For clarity purposes, FIG. 1 depicts only the former scenario.

Once the intended recipient (e.g., user 38) has been identified, attachment system 32 will attach an alert code the transaction data sent to merchant 40 during approval or denial of the underlying commercial transaction. For example, if user 38 is purchasing a meal at a restaurant, the alert code will be attached to transactional data that is printed on the receipt that user 38 must sign. The alert code can be any combination of letters, symbols, and numbers that will alert user 38. Moreover, the alert code can be a code that merely instructs user 38 to contact message center 44. In this case, the alert code need never change. Alternatively, the alert code can vary depending on the particular sender 36. For example, an alert code of “911” could instruct user 38 that his/her spouse has a message. User 38 could then either contact message center 44 to retrieve the message, or contact sender 36 directly. To foster this capability, user 38 could establish a contact list during subscription as an account option. Each contact would be assigned (either by user 38 or alert system 24) their own alert code. Thus, when user 38 sees a particular alert code, user 38 could readily identify the particular sender 36 and contact him/her directly without contacting message center 44. After retrieving the message from sender 36, user 38 can communicate with message center after contacting sender 36 so that alerts can be ceased.

In an alternatively embodiment, user 38 could designate that he/she will communicate with message center 44 to retrieve messages from certain contacts on the list, and directly communicating with other contacts. For the contacts user 38 will communicate with directly, user 38 could also request that an alert be attached only to a certain number of transactions (e.g., one, two, etc.) after a message has been left. This avoids the user 38 having to receive numerous unnecessary alerts for a message already retrieved.

In the event sender 36 leaves the message at the message center 44, user 38 could contact message center 44 and retrieve the message by providing his/her unique identifier. This is accomplished via message transmission system 34, which similar to message reception system 26 and can be any combination of hardware, software, and/or personnel. If message transmission system 34 is automated, user 38 could be prompted to enter his/her unique identifier (e.g., PIN) using touch tones to retrieve the message (e.g., hear the recorded message, or be connected to a live person who will read the message). Once user 38 has retrieved the message, attachment system 32 will cease attaching alerts. Optionally, message transmission system 34 could also send a confirmation of retrieval to sender 36. This can be either accomplished by direct live contact by message center 44, or by electronic means (e.g., an electronic mail message similar to a read receipt). In either event, the confirmation of retrieval could be made standard for all messages, or could be on the basis of request by sender 36 in exchange for a fee.

It should be appreciated in addition to attaching an alert code to transaction data, alert system 24 could alert merchant 40 (where merchant 40 is a live business as opposed to an automated machine). For example, if user 38 is attempting to purchase a meal in a restaurant with a credit card, the credit card machine could make a unique sound indicating the presence of the alert code. This helps ensure that merchant 40 is aware of the alert code. Alternatively, the digital display of the credit card machine could display the terms “ALERT CODE” or the like, which would similarly alert merchant 40.

It should be understood that many variations exist for attaching alerts under the present invention. For example, in another embodiment, an alert code need not be sent only in response to a message left by sender 36. For example, user 38 could interface with subscription system 26 (e.g., via telephone or computer) to indicated that he/she will contact message center 44 to check for messages. Based upon this request, user's 38 account could be flagged so that an alert code is attached to all future transactions until user 38 calls in for his/her messages. Upon calling in, the alert codes could be ceased, or user 38 could request for them to continue until he/she calls in again.

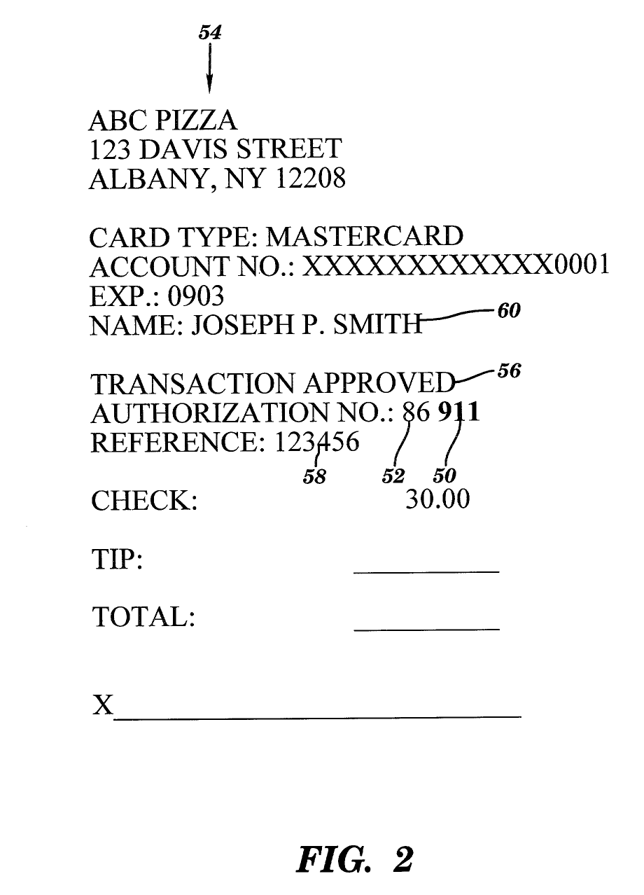

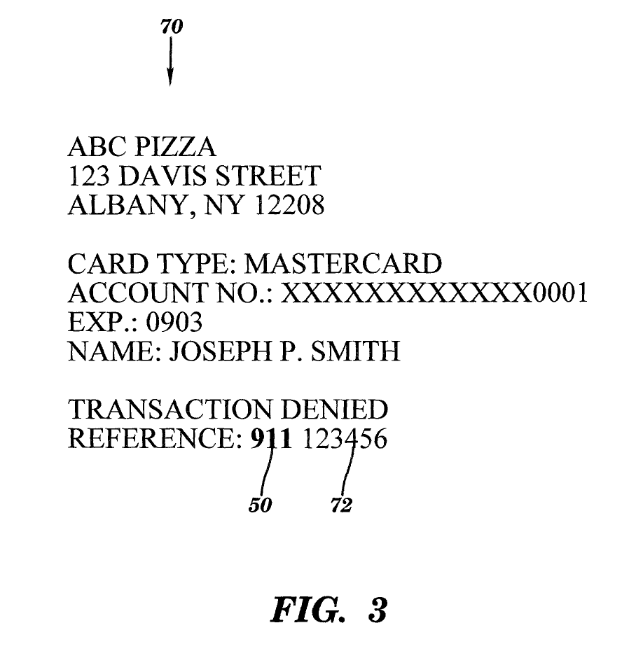

Referring now to FIG. 2, one example of an alert code 50 attached to transaction data 52 is shown. Specifically, FIG. 2 depicts a credit card receipt 54 used to purchase a meal. As depicted, alert code 50 is appended to transaction data 52. As explained above, when user 38 attempts to purchase the meal, merchant 40 will issue a transaction request seeking authorization for the transaction. When credit card receipt 54 is printed, user 38 will see alert code 50. It should be appreciated that although alert code 50 is shown appended to an authorization code, other variations exist. For example, alert code 50 could be attached to any type of transaction data (e.g., approval notification 56, reference number 58, identification 60, etc.) that merchant 40 or user 38 might view. Moreover, although alert code 50 is shown appended to transaction data 52, it should be appreciated that alert code 50 could be prepended to (as shown in FIG. 3) or embedded in (not shown) transaction data 52.

Referring now to FIG. 3, a credit card receipt 70 for a declined transaction is shown. In this scenario, user 38 has attempted to purchase a meal at a restaurant, but the credit card used for the transaction has been declined. Under the present invention, a declined transaction could still result in a receipt 70 being printed out. Thus, even if use of a transactional device is declined, an alert code 50 for a message can still be delivered. Since the transaction was declined, no authorization code is printed. However, as indicated above, alert code 50 can be attached (e.g., prepended) to any type of transaction data 72 that is present such as a reference number as shown. In the event that no receipt is printed for a declined transaction, alert system 24 could otherwise inform user 38 and/or merchant 40 via audible sounds or readable displays in merchant's 40 equipment.

In a typical embodiment of the present invention, the alert code is unrelated to the underlying transaction. That is, the alert code has no bearing on completion of the underlying transaction. Rather, the alert code is to alert user 38 of a message left sender 36. In addition, the message itself can be un-related to the underlying commercial transaction. For example, the message could be a personal message from user's 38 spouse. Moreover, the message could be sent by user 38 his/herself such as an appointment reminder.

As indicated above, merchant 40 need not be a live business such as a restaurant, hotel, or store. Rather, merchant 40 could be an automated machine such as an ATM or gasoline pump. In either event, an alert code can be printed on a receipt, displayed on a display screen, or indicated via audible sounds.

Referring back to FIG. 1, communication with computer system 10 occurs via communication links 42. Communications links 42 can include a direct terminal connected to the computer system 10, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

It is understood that the present invention can be realized in hardware, software, or a combination of hardware and software. Moreover, computer system 10 according to the present invention can be realized in a centralized fashion in a single computerized workstation, or in a distributed fashion where different elements are spread across several interconnected systems (e.g., a network). Any kind of computer/server system(s)—or other apparatus adapted for carrying out the methods described herein—is suited. A typical combination of hardware and software could be a general purpose computer system with a computer program that, when loaded and executed, controls computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for receiving an alert code in a commercial transaction, comprising the steps of:
using a transactional device in a commercial transaction; and
receiving an alert code attached to transaction data for the commercial transaction.

2. The method of claim 1, further comprising the steps of:
contacting a message center with a message, prior to the using step; and
receiving a transaction request, after the using step.

3. The method of claim 2, further comprising the steps of:
attaching an alert code to transaction data in response to the transaction request, prior to the receiving step;
sending the alert code attached to the transaction code; and
retrieving the message in response to the received alert code.

4. The method of claim 3, wherein the retrieving step comprises the steps of:
contacting the message center;
providing a unique identifier; and
retrieving the message from the message center.

5. The method of claim 3, wherein the retrieving step comprises retrieving the message from a sender.

6. The method of claim 1, wherein the transactional device is selected from the group consisting of a magnetic device, and a machine-readable code containing device.

7. The method of claim 1, wherein the alert code is unrelated to the commercial transaction.

8. The method of claim 1, wherein the alert code is appended to the transaction code.

9. The method of claim 1, wherein the alert code is prepended to the transaction code.

10. A method for receiving an alert code in a commercial transaction, comprising the steps of:
contacting a message center with a message;
using a transactional device in a commercial transaction;
identifying an intended recipient of the message;
attaching an alert code to transaction data for the transaction, wherein the alert code is unrelated to the transaction;
receiving the alert code attached to the transaction data; and
retrieving the message in response to the received alert code.

11. The method of claim 10, wherein the retrieving step comprises the steps of:
contacting the message center;
providing a unique identifier corresponding to the intended recipient; and
retrieving the message from the message center.

12. The method of claim 10, wherein the retrieving step comprises retrieving the message from a sender.

13. The method of claim 10, wherein the transactional device is a magnetic device.

14. The method of claim 10, wherein the attaching step comprises appending an alert code to transaction data for the transaction.

15. The method of claim 10, wherein the attaching step comprises embedding an alert code to transaction data for the transaction.

16. The method of claim 10, further comprising the step of alerting a transactional clerk of the contact.

17. A system for receiving an alert code in a commercial transaction, comprising:
a message reception system for receiving a message;
a recipient identification system for identifying an intended recipient of the message based upon use of a transactional device during a commercial transaction;
an attachment system for attaching an alert code to transaction data for the transaction; and
a message transmission system for transmitting the received message.

18. The system of claim 17, wherein the message reception system records the message, and wherein the message transmission system plays the recorded message.

19. The system of claim 17, wherein the recipient identification system identifies the intended recipient based upon a transactional device identification.

20. The system of claim 17, wherein the alert code is unrelated to the commercial transaction.

21. The system of claim 17, further comprising a subscription system for the intended recipient to subscribe to a message service.

22. A program product stored on a recordable medium for receiving an alert code in a commercial transaction, which when executed, comprises:
program code configured to receive a message;
program code configured to identify an intended recipient of the message based upon use of a transactional device during a commercial transaction;
program code configured to attach an alert code to transaction data for the commercial transaction; and
program code configured to transmit the received message.

23. The program product of claim 22, wherein program code configured to receive the message records the message, and wherein program code configured to transmit the received message plays the recorded message.

24. The program product of claim 22, wherein program code configured to identify the intended recipient identifies the intended recipient based upon a transactional device identification.

25. The program product of claim 22, wherein the alert code is unrelated to the commercial transaction.

26. The program product of claim 22, further comprising program code configured to allow the intended recipient to subscribe to a message service.
